(19) United States
(12) Patent Application Publication
(10) Pub. No.: US 2015/0254674 A1
(43) Pub. Date: Sep. 10, 2015

(54) RETURN MERCHANDISE AUTHORIZATION FOR DIGITAL STORAGE DEVICES

(71) Applicant: HGST Netherlands B.V., Amsterdam (NL)

(72) Inventor: David R. Hall, Rochester, MN (US)

(73) Assignee: HGST Netherlands B.V., Amsterdam (NL)

(21) Appl. No.: 14/197,006

(22) Filed: Mar. 4, 2014

(51) Int. Cl. G06Q 30/00

(52) U.S. Cl. CPC G06Q 30/012

(57) ABSTRACT

Disclosed herein is a return merchandise authorization apparatus for a digital storage device that includes a diagnostic module that diagnoses a condition of the digital storage device. The apparatus also includes a certificate authorization module that authorizes use of a return merchandise authorization certificate based at least partially on the condition of the digital storage device. Additionally, the apparatus includes a disable module that disables at least one operation of the digital storage device based on authorization of the use of the return merchandise authorization certificate.

### FIELD

This disclosure relates generally to electronic devices, and more particularly to the authorization and implementation of a return of digital storage devices.

### BACKGROUND

A return merchandise authorization (RMA) is part of a process for returning a product under warranty in exchange for a refund, replacement, or repair. The RMA process may include contacting a manufacturer of the product or service provider selling the product to request a return of the product. In order for the product to be returned, the RMA process requires the manufacturer or service provider to approve the return. Approval of the return may include the issuance of an authorization number or code to be returned along with the product. Once approved, the product can be returned to the manufacturer or service provider.

### SUMMARY

The subject matter of the present application has been developed in response to the present state of the art, and in particular, in response to problems and shortcomings of conventional return merchandise authorization apparatus, systems, and methods that have not yet been fully solved by currently available systems. Certain problems may arise for the return merchandise authorization (RMA) of digital storage devices, such as hard disk drives, solid state drives, and other electronic devices. For example, some consumers, such as cloud-based service providers, utilize vast quantities of digital storage devices to securely store large amounts of data for customers. Due to the sensitivity of the stored data, these and other customers may be hesitant to physically return a digital storage device to the manufacturer for credit. Preferably, some customers desire to receive a credit for a returned digital storage device while retaining possession of the returned digital storage device or discarding the digital storage device themselves. But, manufacturers of digital storage devices have an interest in determining whether a device for which a return is sought is indeed defective, determining the cause of the defect, and preventing unauthorized sales or uses of a returned digital storage device to prevent duplicate return attempts and potential damage to the goodwill of the manufacturer.

Often, the manufacturer of the return digital storage device will authorize a credit to such customers for a return of the digital storage device, while allowing the customers to physically retain the digital storage device as long as the manufacturer can confirm the existence of a defect in the digital storage device, the cause of the defect, and/or the digital storage device will not be used for unauthorized purposes. However, it can be difficult for manufacturers to ensure the existence and cause of a defect are valid, and that returned digital storage devices retained by a customer are not used or used only for authorized purposes. In general, the subject matter of the present application has been developed to provide RMA apparatus, systems, and methods that facilitate flexibility in how a digital storage device is returned by a customer while ensuring the return is for a valid reason and proper use or nonuse of a returned digital storage device physically retained by the customer, which overcomes at least some of the above-discussed shortcomings of the prior art.

According to one embodiment, a return merchandise authorization apparatus for a digital storage device includes a diagnostic module that diagnoses a condition of the digital storage device. The apparatus also includes a certificate authorization module that authorizes use of a return merchandise authorization certificate based at least partially on the condition of the digital storage device. Additionally, the apparatus includes a disable module that disables at least one operation of the digital storage device based on authorization of the use of the return merchandise authorization certificate.

In some implementations of the apparatus, the disable module disables read and write operations of the digital storage device. According to yet certain implementations of the apparatus, the condition of the diagnostic module includes a defect of the digital storage device. The condition of the diagnostic module includes a performance characteristic of the digital storage device in some implementations of the apparatus.

According to certain implementations of the apparatus, the certificate authorization module deactivates the return merchandise authorization certificate following authorization of the return merchandise authorization certificate. In some implementations of the apparatus, the disable module re-enables the at least one operation based on an authorization key issued by a service provider. The diagnostic module can generate a request for approval of a return merchandise authorization for the digital storage device based on the condition of the digital storage device in various implementations of the apparatus.

In certain implementations of the apparatus, the diagnostic module diagnoses the condition of the digital storage device automatically. According to yet some implementations of the apparatus, the diagnostic module diagnoses the condition of the digital storage device when manually requested. The certificate authorization module can authorize use of the return merchandise authorization certificate based on the condition of the digital storage device meeting a predetermined threshold in some implementations of the apparatus.

According to yet another embodiment, a return merchandise authorization system includes a digital storage device that stores a return merchandise authorization certificate. The system also includes a return merchandise authorization control module that diagnoses a condition of the digital storage device, authorizes use of the return merchandise authorization certificate based at least partially on the condition of the digital storage device, and disables at least one operation of the digital storage device based on authorization of the return merchandise authorization certificate.

In some implementations of the system, the at least one operation of the digital storage device includes read and write operations of the digital storage device. The disable module can disable only the read and write operations of the digital storage device based on authorization of the return merchandise authorization certificate. According to certain implementations, the return merchandise authorization control module is located on the digital storage device.

According to some implementations, the system further includes a server in communication with the digital storage device via a data network. The server can be remote from the digital storage device and the return merchandise authorization control module can be located on the server.

In certain implementations, the system includes a return merchandise authorization station in communication with the digital storage device. The return merchandise authorization station can be local to the digital storage device. Additionally, the return merchandise authorization control module can be located on the return merchandise authorization station. The digital storage device is plugged into the return merchandise authorization station according to some implementations of the system.

According to some implementations, the system includes a server in communication with the digital storage device via a data network. The server can be remote from the digital storage device. In certain implementations, the server can include a return authorization credit module that issues a credit to a user in response to authorization of the use of the return merchandise authorization certificate by the return merchandise authorization control module. In yet some implementations, the server can include a re-enablement module that issues an authorization key for re-enabling the at least one operation of the digital storage device via activation of a dormant return merchandise authorization certificate stored on the digital storage device.

In yet another embodiment, a method for authorizing the return of merchandise includes diagnosing a condition of a digital storage device, authorizing use of a return merchandise authorization certificate based at least partially on the condition of the digital storage device, and disabling at least one operation of the digital storage device based on authorization of the use of the return merchandise authorization certificate. The at least one operation consists of a read operation and a write operation in some implementations of the method.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a schematic block diagram illustrating one embodiment of a return merchandise authorization (RMA) system;

FIG. 2 is a schematic block diagram illustrating another embodiment of an RMA system;

FIG. 3 is a schematic block diagram illustrating yet another embodiment of an RMA system;

FIG. 4 is a schematic block diagram illustrating one embodiment of an RMA module of an RMA system; and

FIG. 5 is a schematic flow diagram illustrating one embodiment of a method for authorizing the return of merchandise.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

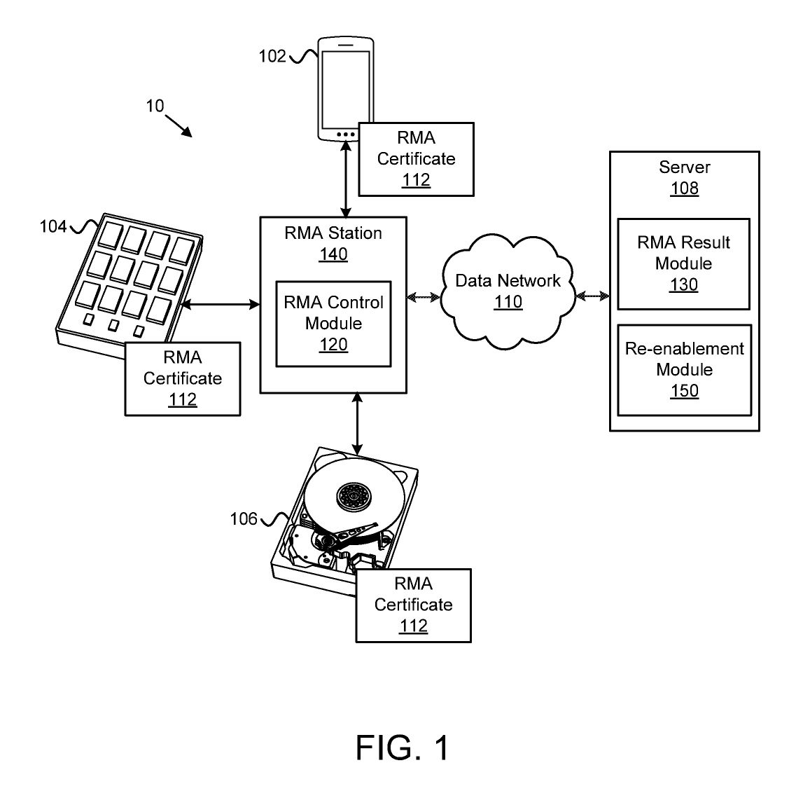

FIG. 1 illustrates one embodiment of a return merchandise authorization (RMA) system 10. The RMA system 10, in certain embodiments, includes at least one digital storage device, such as an information handling device 102, a solid state drive 104, and a hard disk drive 106, a server 108, a digital communication data network 110, and an RMA station 140, which are described in more detail below. Although the RMA system 10 illustrated in FIG. 1 includes a certain number and intercommunication configuration of elements, such as one information handling device 102, one solid state drive 104, one hard disk drive 106, one server 108, one data network 110, and one RMA station 140, in other embodiments, the system can include any number of and intercommunication configuration of elements as desired without departing from the essence of the present disclosure. For example, the RMA system 10 can have more than one information handling device 102, more than one solid state drive 104, and/or more than one hard disk drive 106. Alternatively, the RMA system 10 may include devices other than those shown in FIG. 1, or may omit any one or more of the devices shown in FIG. 1. For example, in one implementation, the RMA system 10 includes one or more hard disk drives 106, but does not include the information handling device 102 and solid state drive 104.

The information handling device 102, in one embodiment, may include one or more mobile computing devices, such as smart phones, tablet computers, laptops, optical head mounted displays, smart watches, and/or the like. In one embodiment, the information handling device 102 can include one or more immobile or stationary computing devices, such as desktop computers, servers, and/or the like. In yet some embodiments, the information handling device 102 can be any of various other electronic devices not primarily used for computing, such as refrigerators, televisions, microwaves, audio playback devices, video playback devices, cameras, and the like. In some embodiments, the information handling device 102 includes operating systems, such as various versions of mobile and desktop operating systems provided by Microsoft®, Apple®, Linux, Android, and/or the like. For example, the information handling device 102 may include a tablet running a version of Apple® iOS, a smart phone running a version of Windows® Mobile, or a laptop running a distribution of Linux. Additionally, the information handling devices 102 may include any of various types of data storage devices for storing data. The data storage devices of the information handling devices 102 can be configured to read data from and/or write data to data storage media of the data storage devices. The information handling device 102 is considered a digital storage device because it has at least some capacity to store data (e.g., read and/or write data).

The solid state drive 104 can be one or more data storage devices that utilize integrated circuit assemblies as memory for storing data. Unlike hard disk drives, the solid state drive 104 does not have moving mechanical components. The solid state drive 104 may use NAND-based flash memory to retain data without power, random-access memory (RAM) that retain data with power, or other integrated circuit based memory. The integrated circuit assemblies are controlled to write data to and read data from integrated circuits of the assemblies.

The hard disk drive 106 can be one or more data storage devices that utilize magnetic recording media (e.g., disks) to store data. Generally, the hard disk drive 106 includes a transducer head, e.g., read-write head, with a writing component that magnetically polarizes areas or bits of the magnetic recording media with one or two polarities to encode either binary zeros or ones. Thus, data is recorded as magnetically encoded areas or bits of magnetic polarity. The direction of the magnetization points in different directions, which can be referred to as a positive state and a negative state. Each bit can store information (generally binary information in the form of either a 1 or a 0) according to the magnetic polarization state of the bit. Typically, bits are arranged along respective radially-adjacent (e.g., concentric) annular tracks of a disk. A single disk can include space for millions of tracks each with millions of bits. A transducer head also includes a reading component that detects the magnetic polarity of each bit or area and generates an electrical signal that approximates the magnetic polarity. The signal is processed to recover the binary data recorded on the magnetic material. In certain implementations, the hard disk drive 106 can be an optical drive, such as a CD, DVD, or Blu-ray drive, that uses laser light or electromagnetic waves to read and write data from optical disks.

During the manufacturing stage of the digital storage devices (e.g., information handling device 102, solid state drive 104, and hard disk drive 106), the manufacturer may generate a unique electronic RMA certificate 112 and store the RMA certificate in the memory of each digital storage device. In some implementations, each RMA certificate 112 is stored in a reserved area of a memory of a digital storage device. Each RMA certificate 112 is considered an active RMA certificate because it is accessible by the digital storage device in which it is stored to execute an RMA process. In one implementation, the RMA certificate is activated during the manufacturing stage before providing the digital storage device to the end-consumer for use.

According to some implementations, the manufacturing stage may include generating a plurality of RMA certificates for each digital storage device and storing the RMA certificates in the memory of each digital storage device. In other words, each digital storage device may include a plurality of RMA certificates. At the time of manufacturing, one of the RMA certificates is activated while the other RMA certificates are not activated, and thus are considered dormant or non-active RMA certificates. The dormant RMA certificates are not accessible by the digital storage device in which they are stored. Accordingly, the dormant RMA certificates cannot be used to execute an RMA process. However, in some implementations, after an active RMA certificate is used to complete an RMA process for a given digital storage device, a dormant RMA certificate can be activated via an authorized key to execute an additional RMA process for the digital storage device. The authorized key can be issued by a re-enablement module 150 of the server 108 in certain implementations.

One or more of the digital storage devices (e.g., information handling device 102, solid state drive 104, and hard disk drive 106) of the system includes self-diagnostic capabilities in some embodiments. Self-diagnostic capabilities can include various inquiry and sensing functionality to diagnose the operating conditions of a digital storage device. Part of the self-diagnostic capabilities may include creating a log on the digital storage device and storing diagnostic data in the log.

The server 108 can be one or more servers. As defined herein, a server can be any of various computing devices that manage access to a centralized resource or service within a computing network. Each server, in one embodiment, includes main frame computers, desktop computers, laptop computers, cloud servers, smart phones, tablet computers, and/or the like. The server 108 includes an RMA result module 130 and re-enablement module 150.

The RMA credit module 130 is configured to implement a desired result based on an approved RMA request. The desired result can be any of various results or options made available by the RMA process of a manufacturer or service provider. The results can include one or more of a refund or credit for a returned digital storage device, replacement of a returned storage device, and repair of a returned storage device. Again, as defined herein, a returned storage device is defined as a device for which an RMA has been successfully performed, whether the device has been physically returned or not. In one implementation, an RMA is requested by a consumer of a digital storage device, which may be defective or underperforming, for a full or partial credit in exchange for returning the device. If the RMA request is granted, the RMA result module 130 processes and/or provides to the consumer the full or partial credit. Similarly, should the consumer desire an exchange or repair, the RMA result module 130 can be configured to facilitate the exchange or repair process.

The re-enablement module 150 is configured to generate or issue a key for enabling or activating an inactive or dormant RMA certificate stored on a digital storage device. The key may be communicated to one of the digital storage devices of the system 10, which accesses the key to reactivate the dormant RMA. A consumer can request a key from the server 108 should the consumer desire to use a disabled operation of the digital storage device that has been disabled during a successful RMA process.

The data network 110, in certain embodiments, is a digital communication network that transmits digital communications between electronic devices of the system 10. In some implementations, the data network 110 may include a wireless network, such as a wireless telephone network, a local wireless network, such as a Wi-Fi network, a Bluetooth® network, and the like. In yet some implementations, the data network 110 may include a wide area network (“WAN”), a storage area network (“SAN”), a local area network (“LAN”), an optical fiber network, the internet, or other digital communication network known in the art. The data network 110 may include two or more networks. Additionally, the data network 110 may include one or more servers, routers, switches, and/or other networking equipment. The data network 110 may also include computer readable storage media, such as a hard disk drive, an optical drive, non-volatile memory, random access memory (“RAM”), or the like.

The RMA station 140 of the system 10 can be communicatively coupled to the digital storage devices. For example, as shown in FIG. 1, the information handling device 102, solid state drive 104, and hard disk drive 106 each communicate with the RMA station 140 via any of various methods of electronic communication. In some embodiments, the RMA station 140 is located in close proximity to the digital storage devices (e.g., on-site at the consumer's place of business), and communicates with the devices over a local-area mode of communication. For example, in certain implementations, the RMA station 140 includes one or more ports or docking stations with which the digital storage devices can interface and through which the digital storage devices may communicate with the RMA station 140. In one implementation, the digital storage devices interface with the RMA station 140 via any of various types of wires or cables having any of various connector configurations (e.g., Ethernet, USB, HDMI, multi-pin, and the like). In other implementations, the digital storage devices may interface directly with the RMA station 140 via a docking port configured to receive a corresponding docking interface of the digital storage device. In yet other implementations, the digital storage devices may communicate with the RMA station 140 over a wireless network.

Regardless of the type of interface or coupling technique, the RMA station 140 can be coupled to the digital storage devices to access data and/or execute programs on the digital storage devices. Generally, the RMA station 140 accesses a digital storage device to determine if the device is defective or underperforming so as to warrant the return of the device via an RMA. Accordingly, in some implementations, the RMA station 140 includes an RMA control module 120 for facilitating an RMA process. The RMA control module 120 is configured to diagnose a digital storage device for defects and/or underperformance, pull or access an active RMA certificate from the digital storage device, and disable at least one operation of the digital storage device in association with pulling the active RMA certificate.

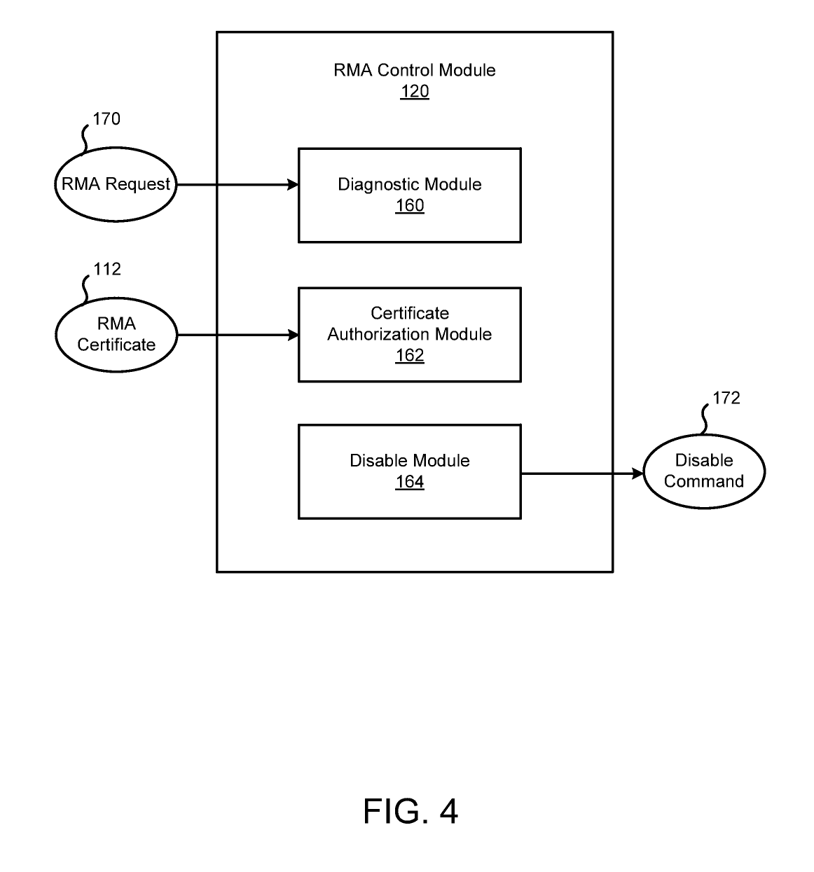

Referring to FIG. 4, according to one embodiment, the RMA control module 120 includes a diagnostic module 160, a certificate authorization module 162, and a disable module 164. In one implementation, the diagnostic module 160 is configured to diagnose one or more conditions of a digital storage device of the system 10 in response to receiving an RMA request 170. The RMA request 170 may be generated by a user of the digital storage device who desires to return the device via an RMA process. The user may generate the RMA request 170 by manually (e.g., in an unsolicited manner) executing an RMA process option on an interface of the RMA station 140 and/or the digital storage device. In another implementation, the RMA request 170 is generated automatically when the digital storage device is communicatively coupled to the RMA station 140. After being generated, the RMA request 170 is communicated to the diagnostic module 160 to initiate the diagnosis of the conditions of the digital storage device. Accordingly, in certain implementations, the monitoring and diagnosis of the conditions of the digital storage device associated with an RMA process are initiated manually by a user via the selection of an RMA request 170.

Alternatively, in some implementations, the diagnostic module 160 is configured to actively monitor operating conditions of the digital storage device associated with an RMA process. In one implementation, a user may manually generate an RMA request 170 as with the above implementations. The diagnostic module 160 having been actively monitoring the operating conditions of the digital storage device would then be able to determine whether the conditions satisfy an RMA requirement (e.g., meets an underperformance threshold, or one or more features of the device are defective) quicker than those implementations where the RMA request 170 merely initiates the monitoring. According to another implementation, while the diagnostic module 160 is actively monitoring RMA conditions, should the conditions satisfy a requirement for RMA, the diagnostic module may prompt a user that an RMA condition has been satisfied and the device qualifies for a return via an RMA process. In other words, the diagnostic module 160 can be configured to request from a user approval to return the device. The user can then select whether to return the device, which acts as an ex post facto RMA request 170, or not return the device. In yet another implementation, the diagnostic module 160 can be configured to automatically generate an RMA request 170 to return the device if the diagnostic module finds that one or more conditions satisfy the requirements for RMA (e.g., a return-inducing condition of the device has been detected). In this manner, the RMA control module 120 is configured to initiate, execute, and complete an RMA without additional input from a user.

When an RMA request 170 has been generated, and the diagnostic module 160 determines that the conditions of a digital storage device have met one or more RMA requirements, the certificate authorization module 162 probes the digital storage device for an active RMA certificate 112. If an active RMA certificate 112 is found on the digital storage device, then the certificate authorization module 162 pulls or accesses the RMA certificate, such as for verification or authorization of the certificate. After authorizing an active RMA certificate 112, the disable module 164 deactivates the RMA certificate and generates a disable command 172. In some implementations, the RMA certificate 112 is deactivated by discarding or deleting the RMA certificate from memory on the digital storage device. In other implementations, the RMA certificate 112 is deactivated by modifying the RMA certificate to render it deactivated or usable for future RMA processes.

The disable command 172 is transmitted to the digital storage device being returned. Furthermore, the disable command 172 includes a command to disable one or more operations or functionality of the digital storage device. In response to receiving the disable command 172, the digital storage device disables the one or more operations indicated in the disable command. The disabled operation or operations can be any of various operations of the digital storage device. Preferably, however, the disable module 164 commands the disablement of an operation or operations central to the core functionality of the digital storage device such that disablement of the operation or operations would render the digital storage device useless for its primary purpose. For example, in some implementations, read and/or write operations of the solid state drive 104, hard disk drive 106, or other memory drive would be disabled by the disable module 164. While other operations of the memory drives, such as inquiry and sensing operations, may remain operational, disabling the read and/or write operations of memory drives would render the drives useless for their primary purpose of storing and retrieving data. For other types of data storage devices, such as information handling devices as defined above, the disable module 164 may disable the same or other types of operations. For example, and without limitation, the disable module 164 may disable operating systems for computers, tablets, laptops, and the like, incoming and/or outgoing call functionality for cellphones and smartphones, refrigeration for refrigerators, video display for televisions, and image capturing functionality for cameras. The disabling of core operations of a data storage device deters a user from future unauthorized use of the device.

In some implementations, the disable module 164 may also be configured to re-enable a previously disabled operation. As mentioned above, the RMA system 10 can include a re-enablement module 150 that issues an authorization key for re-enabling previously disabled operations. The key can be received by the certificate authorization module 162, which activates a dormant RMA certificate. In response to an active RMA certificate being produced by the certificate authorization module 162, the disable module 164 is configured to re-enable the previously disabled operation or operations.

According to the RMA system 10 of FIG. 1, the digital storage devices communicate with the RMA station 140, which communicates with the server 108 via the data network 110. In this manner, the digital storage devices communicate directly with the RMA station 140 and indirectly with the server 108 via the RMA station 140. Additionally, in the RMA system 10, the RMA control module 120 is located on the RMA station 140. Moreover, the RMA system 10 includes a single RMA control module 120 that operates to control an RMA process for one or multiple digital storage devices of the system.

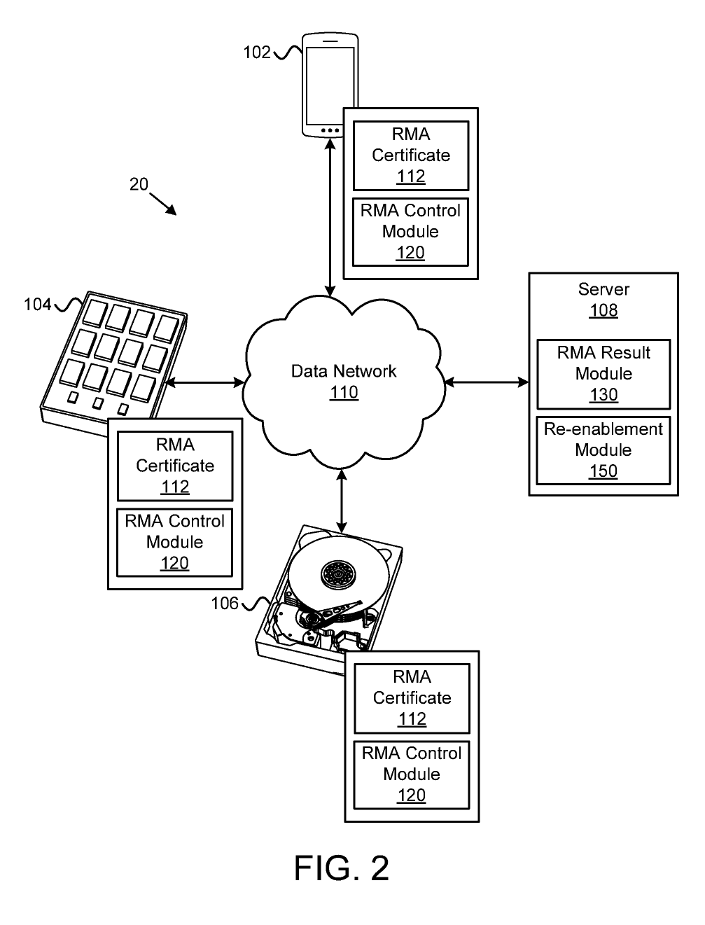

In contrast to FIG. 1, an RMA system 20 of FIG. 2 includes multiple RMA control modules 120 each associated with a respective one of the digital storage devices of the system. In view of this configuration, each digital storage device of the system 20 can communicate directly with the server 108 via the data network 110. The RMA control module 120 of each digital storage device is configured in the same or similar manner as the RMA control module 120 of the RMA station 140 in FIG. 1. For example, the RMA control module 120 of each digital storage device (e.g., information handling device 102, solid state drive 104, and hard disk drive 106) includes a diagnostic module 160, a certificate authorization module 162, and a disable module 164. Accordingly, instead of the diagnosis of the digital storage devices being initiated and controlled by a separate device (e.g., the RMA station 140), each digital storage device is capable of diagnosing itself via the diagnostic module 160 located on the digital storage device. Additionally, each digital storage device of the RMA system 20 authorizes its own RMA certificate 112 via the certificate authorization module 162 located on the digital storage device, and disables its own operations via the disable module 164 located on the digital storage device.

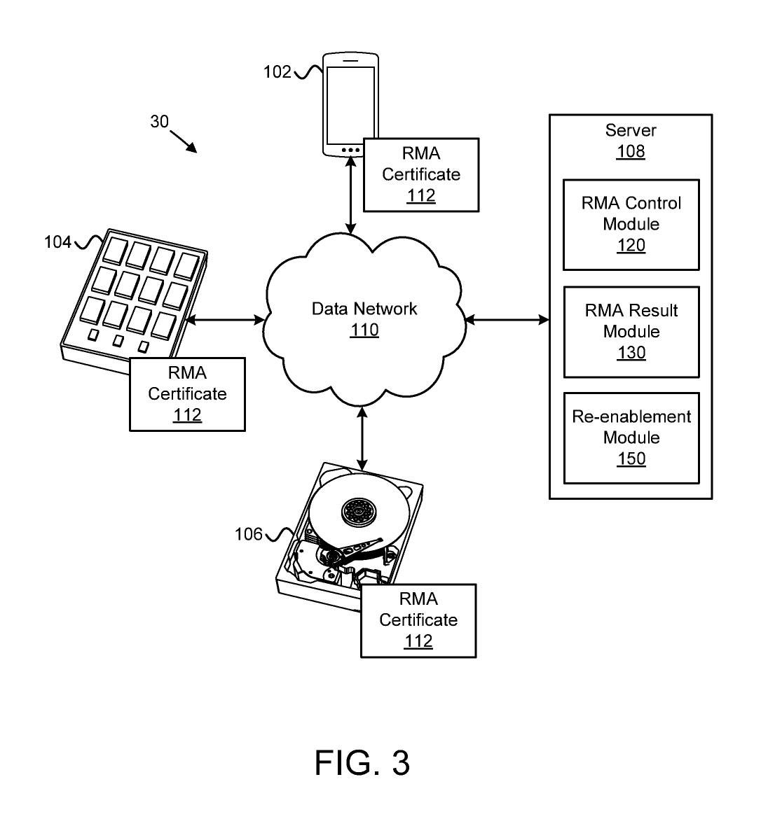

Referring to FIG. 3, an RMA system 30 is shown that is configured differently than the RMA systems 10, 20. For example, like the RMA system 10 of FIG. 1, the RMA system 30 includes a single RMA control module 120 that operates to control an RMA process for one or multiple digital storage devices of the system. However, unlike the RMA system 10, the single RMA control module 120 is located on the server 108 instead of an RMA station. In this manner, the RMA system 10 includes a single RMA control module 120 on the server 108 that operates to control an RMA process for one or multiple digital storage devices of the system. Moreover, the server 108 communicates directly with data storage devices of the RMA system 30 via the data network 110 without an intervening RMA station.

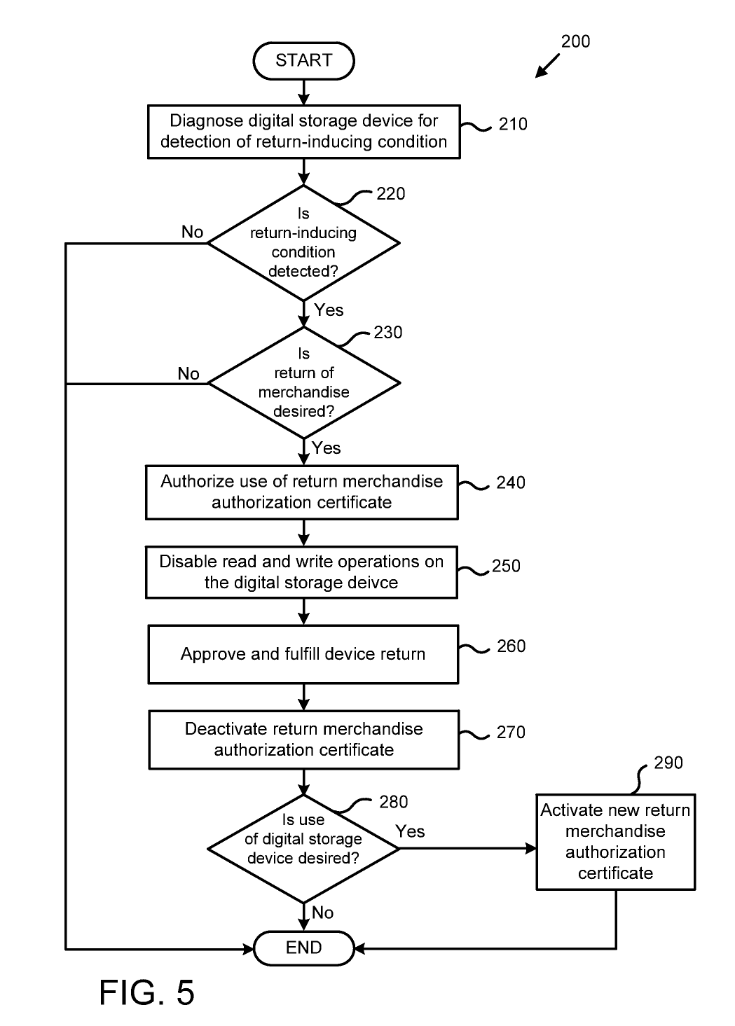

Referring to FIG. 5, one embodiment of a method 200 for authorizing the return of merchandise, such as digital storage devices, is shown. In one implementation, the method 200 can be executed by the RMA systems and associated modules and devices described and shown above. The method 200 starts by diagnosing a digital storage device to detect a condition, such as a return-inducing, condition at 210. The diagnosing action at 210 may be preceded by a request to return a digital storage device manually by a user. A return-inducing condition can be any condition that meets the requirements, often set by the manufacturer of or service provider for a digital storage device, for returning a digital storage device. The method 200 includes determining at 220 whether a return-inducing condition is detected at 210. If a return-inducing condition is not detected, as determined at 220, then the method 200 ends. However, if a return-inducing condition is detected, as determined at 220, then the method 200 determines whether a return of merchandise, such as a digital storage device, is desired at 230. The desire to return merchandise can be determined by user input in the form of an RMA request or automatically based on predetermined conditions. If the return of merchandise is not desired at 230, then the method 200 ends. But, if the return of merchandise is desired, the method 200 authorizes the use of, or access to, an RMA certificate at 240.

After the RMA certificate is used at 240, the method 200 disables at least one operation, such as read and write operations, of the digital storage device at 250. Then, the method 200 approves and fulfills the return of the digital storage device at 260, which may include issuing a credit, performing an exchange, or repairing the device in some implementations. At 270, the method 200 deactivates the RMA certificate used at 240. The method 200 can also determine if usage of the returned digital storage device (e.g., a returned device that is retained by the user as is without repair) is desired at 280. In some instances, such as when a device is underperforming for a particular application, a user may desire both a partial credit for the device and the ability to use the device for another application that is more commensurate with the performance level of the device. If continued usage of the returned digital storage device is desired at 280, then the method 200 activates a new RMA certificate at 290, which can result in the re-enablement of the disabled operation(s) of the device can be re-enabled, and the method ends. However, if continued usage of the returned digital storage device is not desired at 280, then the method 200 ends.

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

Aspects of the embodiments may be described above with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

The present subject matter may be embodied in other specific forms without departing from its spirit or essential characteristics. The described embodiments are to be considered in all respects only as illustrative and not restrictive. All changes which come within the meaning and range of equivalency of the claims are to be embraced within their scope.

What is claimed is:

1. A return merchandise authorization apparatus for a digital storage device, comprising:
a diagnostic module that diagnoses a condition of the digital storage device;
a certificate authorization module that authorizes use of a return merchandise authorization certificate based at least partially on the condition of the digital storage device; and
a disable module that disables at least one operation of the digital storage device based on authorization of the use of the return merchandise authorization certificate.

2. The return merchandise authorization apparatus of claim 1, wherein the disable module disables read and write operations of the digital storage device.

3. The return merchandise authorization apparatus of claim 1, wherein the condition of the diagnostic module comprises a defect of the digital storage device.

4. The return merchandise authorization apparatus of claim 1, wherein the condition of the diagnostic module comprises a performance characteristic of the digital storage device.

5. The return merchandise authorization apparatus of claim 1, wherein the certificate authorization module deactivates the return merchandise authorization certificate following authorization of the return merchandise authorization certificate.

6. The return merchandise authorization apparatus of claim 1, wherein the disable module re-enables the at least one operation based on an authorization key issued by a service provider.

7. The return merchandise authorization apparatus of claim 1, wherein the diagnostic module generates a request for approval of a return merchandise authorization for the digital storage device based on the condition of the digital storage device.

8. The return merchandise authorization apparatus of claim 1, wherein the diagnostic module diagnoses the condition of the digital storage device automatically.

9. The return merchandise authorization apparatus of claim 1, wherein the diagnostic module diagnoses the condition of the digital storage device when manually requested.

10. The return merchandise authorization apparatus of claim 1, wherein the certificate authorization module authorizes use of the return merchandise authorization certificate based on the condition of the digital storage device meeting a predetermined threshold.

11. A return merchandise authorization system, comprising:
a digital storage device that stores a return merchandise authorization certificate; and
a return merchandise authorization control module that diagnoses a condition of the digital storage device, authorizes use of the return merchandise authorization certificate based at least partially on the condition of the digital storage device, and disables at least one operation of the digital storage device based on authorization of the return merchandise authorization certificate.

12. The return merchandise authorization system of claim 11, wherein the at least one operation of the digital storage device comprises read and write operations of the digital storage device, and wherein the disable module disables only the read and write operations of the digital storage device based on authorization of the return merchandise authorization certificate.

13. The return merchandise authorization system of claim 11, wherein the return merchandise authorization control module is located on the digital storage device.

14. The return merchandise authorization system of claim 11, further comprising a server in communication with the digital storage device via a data network, the server being remote from the digital storage device, wherein the return merchandise authorization control module is located on the server.

15. The return merchandise authorization system of claim 11, further comprising a return merchandise authorization station in communication with the digital storage device, the return merchandise authorization station being local to the digital storage device, wherein the return merchandise authorization control module is located on the return merchandise authorization station.

16. The return merchandise authorization system of claim 15, wherein the digital storage device is plugged into the return merchandise authorization station.

17. The return merchandise authorization system of claim 11, further comprising a server in communication with the digital storage device via a data network, the server being remote from the digital storage device, wherein the server comprises a return authorization credit module that issues a credit to a user in response to authorization of the use of the return merchandise authorization certificate by the return merchandise authorization control module.

18. The return merchandise authorization system of claim 11, further comprising a server in communication with the digital storage device via a data network, the server being remote from the digital storage device, wherein the server comprises a re-enablement module that issues an authorization key for re-enabling the at least one operation of the digital storage device via activation of a dormant return merchandise authorization certificate stored on the digital storage device.

19. A method for authorizing the return of merchandise, comprising:
diagnosing a condition of a digital storage device;
authorizing use of a return merchandise authorization certificate based at least partially on the condition of the digital storage device; and
disabling at least one operation of the digital storage device based on authorization of the use of the return merchandise authorization certificate.

20. The method of claim 19, wherein the at least one operation consists of a read operation and a write operation.
